(19) United States
(12) Patent Application Publication
(10) Pub. No.: US 2025/0274150 A1
(43) Pub. Date: Aug. 28, 2025

(54) ASSIGNING TRANSMIT SIGNALS FOR SUPERIMPOSED QUADRATURE RECEIVE SIGNAL

(71) Applicant: Microchip Technology Incorporated, Chandler, AZ (US)

(72) Inventors: Axel Heim, Munich (DE); Lionel Portmann, Vaud (CH)

(73) Assignee: Microchip Technology Incorporated, Chandler, AZ (US)

(21) Appl. No.: 18/782,930

(22) Filed: Jul. 24, 2024

Related U.S. Application Data
(60) Provisional application No. 63/562,348, filed on Mar. 7, 2024.
(60) Provisional application No. 63/556,725, filed on Feb. 22, 2024.

(51) Int. Cl. H04B 1/04; H04B 1/00; H04B 1/16

(52) U.S. Cl. CPC H04B 1/0483; H04B 1/0014; H04B 1/16

(57) ABSTRACT

Systems and methods to simultaneously transmit a plurality of transmit signals, assign control logic to assign transmit signals to transmitters, receive a superimposed receive signal comprising a plurality of receive signal components originating from the transmit signals, wherein two receive signal components of the superimposed receive signal are in quadrature. Capacitive touch systems and methods comprising: transmitters of transmit signals; transmit electrodes and a receive electrode positioned to have mutual capacitances between the transmit electrodes and the receive electrode at mutual capacitance nodes, wherein a mutual capacitance at a mutual capacitance node deviates when an interfering object is proximate, wherein the transmit electrodes are physically adjacent, wherein the transmit electrodes are driven by the transmit signals, and a receiver of a superimposed receive signal comprising receive signal components that are in quadrature.

### TECHNICAL FIELD

The present disclosure relates to scanning touch screen electrodes, in particular, aligning signals received by receive electrodes in a quadrature-signal multiple-access sensing system.

### BACKGROUND

A two-dimensional touchscreen is formed by electrodes used as transmitters(X) and electrodes used as receivers(Y), arranged in rows and columns. This forms a matrix of mutual capacitances associated with the nodes between X and Y electrodes. Measuring this matrix is challenging because each Y receiver electrode forms nodes with all the X transmitter electrodes, yet individual nodes should be distinctly measured.

Generally, in transmission schemes using spread-spectrum techniques like, for example, Code-Division Multiple-Access (CDMA) or Code-Division Multiplexing (CDM), the transmitted information can be decoded at the receiver after the entire transmitted sequence has been received. Typically, CDMA transmitters toggle the phase of a carrier signal by 0-degree or 180-degree, according to a so-called spreading sequence.

Quadrature modulation (QM) allows for double the number of transmit electrodes compared to systems with real-valued transmit symbols, or transmit symbols with 180-degree phase shift. In a Quadrature-Signal Multiple-Access Sensing system using a Quadrature Phase Shift Keying (QPSK), two transmit electrodes are simultaneously driven and the two mutual capacitances can be distinguished at the receiver. Unlike CDMA, quadrature modulation (QM) does not rely on multiple chips and sequences of phase changes. These two transmit electrodes are driven in phase quadrature (phase rotation of 90°) and the receiver computes the phasor (both amplitude and phase information) of the received chip. A change of mutual capacitance at one of the mutual capacitance nodes causes a deviation of the received phasor in one direction (for example A), whereas a change of mutual capacitance at the second mutual capacitance node causes a deviation in a direction orthogonal to A. With appropriate geometrical projections of the phasor change, the two mutual capacitances are unambiguously measured. This quadrature driving scheme (based on 90° rotations) may combine with CDMA (based on 1800 rotations). This combined system (QM+CDMA=quadrature code-division multiple-access (QCDMA)) drives multiple transmit electrodes simultaneously with, from one chip to another chip, patterns of phase changes between 0, 90, 180 or 270 degrees. However, one may yield non-zero measurement value changes—suggesting non-zero mutual-capacitance changes—around actually untouched mutual capacitance nodes between X (transmit) and Y (receive) electrodes.

There is a need for reliable quadrature signal systems to resolve non-zero measurement value changes—suggesting non-zero mutual-capacitance changes—around actually untouched mutual capacitance nodes between X (transmit) and Y (receive) electrodes.

### SUMMARY

According to aspects, systems and methods provide for reliable quadrature signal systems to resolve non-zero measurement value changes—suggesting non-zero mutual-capacitance changes—around actually untouched mutual capacitance nodes between X (transmit) and Y (receive) electrodes caused by signal propagation delays.

According to one aspect, there is provided a system comprising: a plurality of transmitters to simultaneously transmit a plurality of transmit signals, one transmit signal per transmitter respectively; assign control logic to assign a first transmit signal to a first transmitter and a second transmit signal to a second transmitter; and a receiver to receive a superimposed receive signal comprising a plurality of receive signal components to originate from the plurality of transmit signals, respectively, wherein a first receive signal component of the superimposed receive signal to originate from the first transmitter and a second receive signal component of the superimposed signal to originate from the second transmitter are to be in quadrature.

According to another aspect, there is provided a method comprising: transmitting respective ones of a plurality of transmit signals from respective ones of a plurality of transmitters, one transmit signal per transmitter respectively; assigning a first transmit signal to a first transmitter and a second transmit signal to a second transmitter; and receiving a superimposed receive signal comprising a plurality of receive signal components originating as the plurality of transmit signals, respectively, wherein a first receive signal component of the superimposed receive signal originating from the first transmitter and a second receive signal component of the superimposed signal originating from the second transmitter are in quadrature.

A further aspect provides a capacitive touch system comprising: a first transmitter to transmit a first transmit signal; a second transmitter to transmit a second transmit signal; first and second transmit electrodes and a receive electrode positioned to have mutual capacitances between respective ones of the first and second transmit electrodes and the receive electrode at mutual capacitance nodes, wherein a mutual capacitance at a mutual capacitance node deviates when an interfering object is proximate, wherein the first and second transmit electrodes are physically adjacent, wherein the first and second transmit electrodes are to be driven by the first and second transmit signals, respectively; and a receiver to receive a superimposed receive signal comprising first and second receive signal components, wherein the first receive signal component of the superimposed receive signal to be received from the first transmitter and the second receive signal component of the superimposed signal to be received from the second transmitter are to be in quadrature.

### BRIEF DESCRIPTION OF THE DRAWINGS

The figures illustrate examples of a mutual capacitive sensing systems and methods to provide for reliable quadrature signal systems to resolve non-zero measurement value changes—suggesting non-zero mutual-capacitance changes—around actually untouched mutual capacitance nodes between X (transmit) and Y (receive) electrodes caused by signal propagation delays.

FIG. 1 shows quadrature TX superposition, where the sinusoidal waveform transmit signal driving tx₁ electrode is at 90° phase rotation (quadrature) relative to the sinusoidal waveform transmit signal driving tx₂ electrode.

FIG. 2A shows a sinusoidal transmit signal driving transmit electrodes tx₁ and tx₂ with a phase shift of 90 degrees between the sinusoidal transmit signals so the signals are in quadrature and there are no interferences at the mutual capacitance nodes.

FIG. 2B shows a sinusoidal transmit signal driving transmit electrodes tx₁ and tx₂ with a phase shift of 90 degrees between the sinusoidal transmit signals so the signals are in quadrature and there is an interference at the mutual capacitance node where the transmit electrode tx₁ intersects with the receive electrode rx₁.

FIG. 2C shows a sinusoidal transmit signal driving transmit electrodes tx₁ and tx₂ with a phase shift of 90 degrees between the sinusoidal transmit signals so the signals are in quadrature and there is an interference at the mutual capacitance node where the transmit electrode tx₂ intersects with the receive electrode rx₁.

FIG. 2D shows a sinusoidal transmit signal driving transmit electrodes tx₁ and tx₂ with a phase shift of 90 degrees so the signals are in quadrature and there is an interference at the mutual capacitance node where the transmit electrode tx₁ intersects with the receive electrode rx₁ and an interference at the mutual capacitance node where the transmit electrode tx₂ intersects with the receive electrode rx₁.

FIG. 3 shows how two different forms of orthogonality may be combined (QM+CDMA).

FIG. 4A shows a general case of QCDMA decoding, where the matrix of received chips R contains complex numbers.

FIG. 4B shows an alternative case of QCDMA decoding.

FIG. 5 shows code variations, wherein rows of the code matrix can be reordered, omitted, and multiplied by −1. Columns of the code matrix can be multiplied by a unity vector of arbitrary phase, two columns of the code matrix can be swapped. Code matrices can be changed between two measurement frames.

FIG. 6 shows a plot of a touch level estimate matrix obtained using the space-time mapping matrix shown in FIG. 7A, with each Tx a row and each time slot a column.

FIG. 7A shows a quadrature transmit electrode pair, which is a set of two transmit electrodes to which the same binary code word is assigned but with a 90 degree phase shift between the two.

FIG. 7B shows code word assignments for transmit electrodes of a capacitive touch sensing system comprising transmit electrodes and receive electrodes positioned to have mutual capacitances between the transmit electrodes and the receive electrodes at mutual capacitance nodes, wherein the mutual capacitance at a mutual capacitance node deviates when an interfering object is proximate. Quadrature transmit electrode pairs are pairs of physically neighboring electrodes.

FIG. 7C shows the code word assignments shown in FIG. 7B, and further shows how configurable transmit electrode phases φ₅, φ₇, φ₉, φ₁₁ may compensate for propagation delay differences between two channels.

FIGS. 8A and 8C show capacitive touch sensing systems, comprising transmit electrodes and receive electrodes, and FIGS. 8B and 8D are graphs showing received signals of the systems, respectively, where an interfering object is proximate the same mutual capacitance node in both systems, but the transmit electrodes are paired differently.

FIG. 9 shows, for each mutual capacitance node, the complex-valued signal deviation for when a reference interfering object is proximate.

FIG. 10 shows a block diagram of a system comprising a plurality of transmitters, assign control logic, propagation delay control logic, and a receiver.

FIG. 11 shows a block diagram of a system comprising a plurality of transmitters, phase shift control logic, propagation delay control logic, and a receiver.

FIG. 12 shows a flow chart of a method comprising: transmitting transmit signals from a plurality of transmitters, assigning transmit signals to transmitters, and receiving a superimposed receive signal.

FIG. 13 shows a capacitive touch sensing system, comprising transmit electrodes positioned horizontally and receive electrodes positioned vertically, and the software code assigns a first transmit signal to transmitter Tx0 and a second transmit signal to transmitter Tx1.

FIG. 14 shows a capacitive touch sensing system, comprising transmit electrodes positioned horizontally and receive electrodes positioned vertically, and the software code assigns a first transmit signal to transmitter Tx0 and a second transmit signal to transmitter Tx1, and further assigns transmit signals to transmitters pairs: Tx2 and Tx3; Tx4 and Tx5; Tx6 and Tx7; Tx8 and Tx9; and Tx10 and Tx11, so received signal components are in quadrature.

FIG. 15 shows a capacitive touch sensing system, comprising transmit electrodes positioned horizontally and receive electrodes positioned vertically, and the software code assigns a first transmit signal to transmitter Tx0 and a second transmit signal to transmitter Tx2, and further assigns transmit signals to transmitters pairs: Tx1 and Tx3; Tx4 and Tx6; Tx5 and Tx7; Tx8 and Tx10; and Tx9 and Tx11, so received signal components are in quadrature.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

A quadrature system using quadrature modulation (QM) is first explained. In QM, two transmit X electrodes are simultaneously driven and the two mutual capacitances are distinguished. Unlike CMDA, quadrature modulation does not rely on multiple chips and sequences of phase changes. In QM, these two transmit X electrodes are driven in phase quadrature (phase rotation of 90°) and the receiver computes the phasor (both amplitude and phase information) of the received signal. A change of mutual capacitance at one of the mutual capacitance nodes causes a deviation of the received phasor in a first direction, whereas a change of capacitance at the second mutual capacitance node causes a deviation in a second direction, which second direction is orthogonal to the first direction. With appropriate geometrical projections of the phasor change, the two mutual capacitances are unambiguously measured. In some aspects, this quadrature modulation scheme (based on a 90° phase shift) may be combined with CDMA (based on 180° phase shifts). This combined system (QM+CDMA=QCDMA) drives multiple X transmitter electrodes simultaneously with, from one chip to another chip, patterns of phase changes between 0, 90, 180 or 270 degrees.

A “phasor” is a scalar complex number, i.e., it can be considered as one vector in a two-dimensional (2D) plane. Amplitude of a phasor means the complex number's absolute value, and phase of a phasor means the complex number's phase. A phase “shift” may be relative to a reference. A “phasor” is an absolute phase, i.e., relative to phase 0.

As used herein, two transmit electrodes are said to be driven “in quadrature” when the transmit signal driving one transmit electrode is phase shifted relative to the transmit signal driving the other transmit electrode, wherein the phase shift is sufficiently orthogonal (+/−90 degrees) to allow the receiver to compute the phasor (both amplitude and phase information) of the received signal so that the two mutual capacitances may be unambiguously measured. The term “quadrature modulation (QM)” means the relative phase shift between the transmit signals applied to two transmit electrodes is, for example, 90 degrees. The relative phase shift may be sufficient to allow the receiver to compute the phasor (both amplitude and phase information) of the received signal so that the two mutual capacitances may be unambiguously measured, wherein the relative phase shift may be 90 degrees, 85-95 degrees, or 80-100 degrees.

Suitable stimulus waveforms may include: sinusoidal (sine and cosine), square waves, impulses. The frequency of the stimulus can be varied. In this context, for periodic waveforms the frequency refers to the inverse of the waveform's period which is a time. For non-periodic waveforms there is still a notion of instantaneous frequency. One example is to change the length of a chip while keeping the number of periods within the chip unchanged. Optionally an envelope may be applied to the waveforms to reduce emissions.

Received phasors (both amplitude and phase information) may be efficiently computed with coherent correlators. CORDIC algorithms may efficiently produce the correlators templates, including envelopes for more effective out of band noise rejection.

Assignment of phase changes patterns may be made with consideration given to the physical position of the X electrodes to compensate phase rotations caused by the material of the sensor.

According to aspects, CDMA signals may be decoded by measuring phasors, and post processing of the phasors may provide for projections and baselines of the CDMA signals. Having “phasors” is independent of CDMA or QM, but is the consequence of doing I/Q demodulation.

For the same amount of time allotted to scan a touchscreen, aspects may improve signal-to-noise ratio (SNR) by 3 dB (½ of the noise power) compared to CDMA without QM. Conversely, for the same SNR, the time to scan a touchscreen may be half compared to CDMA without QM. Implementation of aspects in a microchip may not require an increase in the required memory or the number of mathematical operations compared to CDMA without QM. Aspects of the receiver digital processing may be well suited for sigma delta analog-to-digital conversion (ADC). Consideration of signal propagation delay to resolve non-zero values for non-interfered mutual capacitances associated with the mutual capacitance nodes between X (transmit) and Y (receive) electrodes may improve SNR or reduce the time to scan a touchscreen.

Synchronized transmitters and receivers may share a common “carrier frequency.” This frequency may vary over time following an “instantaneous carrier frequency function.” The signal of receive electrodes may be conditioned by an AFE (analog front end) and then digitized by an analog to digital converter ADC at a rate fs (sampling rate) into a stream of samples. A “chip” is the time interval over which a receiver measures the received signal. During a chip, the receiver estimates the spectral component of the signal matching the instantaneous carrier frequency fc=Fc(t) and computes the amplitude and phase of this component. The influence of noises elsewhere in the spectrum is attenuated. Several digital signal processing (DSP) techniques can be used for extracting a phasor and attenuate other noises: e.g., a coherent homodyne receiver, a correlator, or curve fitting algorithms.

QM may be used to compute either in advance or in real time the transmit signal and either: a) the receiver filters coefficients; b) the correlator templates; or c) the local oscillator (LO) waveforms of a coherent homodyne receiver. These different implementations produce a similar result: a phasor of the received signal during a chip duration. Starting from a function which describes the carrier frequency over time Fc(t), one computes IFc(t), the integral of Fc(t) over time, which is, when multiplied with the factor 2pi, the instantaneous phase of the carrier. Whether one uses an indefinite integral or a definite integral may not be important because it amounts to a phase offset shared by all TX and RX signals, which is called phi0. Stem functions are created and grouped. The transmit waveforms can be produced with one or more D/A converters fed over time with numerical samples. These samples can be computed off line and stored in tables, or can be generated in real time. Either way, the numerical samples are evaluations of the transmit waveform functions at the corresponding sample instant in time. The receiver filter coefficients, or correlation templates, or LO waveforms are typically represented by numerical samples. These samples may be computed off line in advance and stored, or generated in real time.

A receiver with direct sampling and digital I/Q demodulation acquires and samples a number N of analog measurement values at a constant time interval Ts, which are converted to the digital domain using an analog-to-digital converter (ADC), yielding a vector of digital receive samples. For I/Q demodulation down-mixing, this sample vector is then element-wise multiplied with a) cos(2*pi*phi(k*Ts)+phi0) for the inphase component, and b) with sin(−2*pi*phi(k*Ts)−phi0) for the quadrature component, then dot-product multiplying the resulting vectors with a low-pass filter function (e.g., a Hann window function) yielding inphase and quadrature component of a receive signal phasor. For constant carrier frequencies fc, phi(k*Ts)=fc*k*Ts. For a time-variant carrier frequency fc(t), the phase phi(k*Ts) is the integral of fc(t) over time.

The frequency fc(t) is the carrier (or ‘stimulus’) frequency employed at the system transmitter(s), and it can be a function of time t. When fc is changing over time, fc(t) is the instantaneous carrier frequency. The so-called chip length N can, e.g., be N=1000, and the sampling interval Ts can, e.g., be Ts=1/(2.5 MHz).

A coherent homodyne receiver demodulates the signal (mix down) with a local oscillator (LO) whose frequency tracks fc over time. The LO has a pair of outputs, I and Q linked by a 90° phase shift. The mixer outputs are then filtered with low pass filters, yielding at the end of a chip two DC values, the I and Q components of the phasor. Correlators compute the correlation between the vector ADC samples (the I and Q vectors are the components of the phasor) belonging to a chip and two template vectors, I_coeff and Q_coeff. These templates are computed as sinusoids tracking the instantaneous frequency fc=Fc(t) and a phase difference of 900 is kept between I_coeff and Q_coeff. This can be achieved by using sine and cosine functions. Optionally, a filter to attenuate noise is added if a windowing function, like the raised cosine or Hann function, is to be applied either to the vector of ADC samples or to the I_coeff and Q_coeff. Two correlation values are computed of a chip duration, corresponding to the I and Q components of the phasor, Various curve fitting algorithms can also be used to fit two parameters of a sinusoidal function: phase and amplitude, for example, until the error between the vector of ADC samples and the windowing function is reduced, or reduced below a threshold value. Nonlinear optimization techniques may be used.

By using a quadrature modulation (based on a phase shift of 90°), a receiver can scan a touchscreen twice as fast and concurrently measure multiple phasers over overlapping time intervals.

Regarding transmitter quadrature stem functions and two transmit groups, starting from the instantaneous carrier frequency function fc=Fc(t) and IFc(t), its integral, an instantaneous phase function can be defined as: phi(t)=2*pi*IFc(t)+phi0, where phi0 is an arbitrary constant. From phi(t), four sinusoidal functions can be computed, adding each time a 90° phase rotation, e.g., stem0(t)=cos(phi(t)+0*pi), stem1(t)=cos(phi(t)+0.5*pi), stem2(t)=cos(phi(t)+1.0*pi), stem3(t)=cos(phi(t)+1.5*pi). The four sinusoidal functions are the “stems” for creating the actual transmitted waveforms.

Regarding groups, these four functions may be divided into two transmission groups: stem0 and stem2 belong to the group TXI, while stem1 and stem3 belong to the group TXQ.

Each function from TXI has a +90° or −90° phase difference when compared to any function from group TXQ, which is called “quadrature.” Further, two functions within a group may have a 180° phase difference, which is called “polarity inversion.” This means that change of mutual capacitances driven by waveforms from group TXI exhibit a phasor deviation which is perpendicular to phasor deviations otherwise caused by changes of mutual capacitances driven by the other waveforms from group TXQ. Memory-less nonlinear operation on stem(t) functions in general may not affect the properties of quadrature. Therefore, stein function can be shifted. This means the waveforms actually used to drive transmit electrodes can be sinusoidal, square, or impulse, without limitation.

Regarding CDMA codes, it is possible to drive TX electrodes according to one combined CDMA code or two independent CDMA codes.

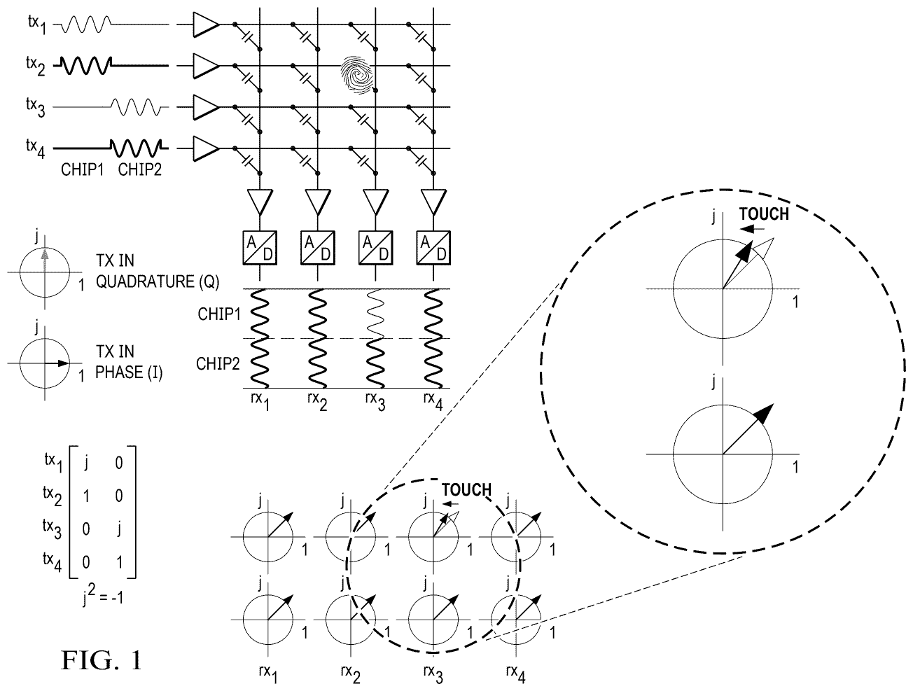

FIG. 1 shows quadrature TX superposition of signals, using a phase shift of 90 degrees. The sinusoidal waveform transmit signal driving tx₁ electrode is at 90° phase rotation (quadrature) relative to the sinusoidal waveform transmit signal driving tx₂ electrode. The sinusoidal waveform transmit signal driving tx₃ electrode is at 90° phase rotation (quadrature) relative to the sinusoidal waveform transmit signal driving tx₄ electrode. The transmit signals are transmitted for two time periods (chip1 and chip2). The amplitude and phase of the phasors are measured by receive electrodes (rx₁, rx₂, rx₃, and rx₄) during both chip1 and chip2. The phasor measured by rx₃ during chip1 indicates an interfering object (e.g., finger) is proximate the tx₂/rx₃ mutual capacitance node at that time. The transmit signal transmitted by tx₂, which is in phase (I), and received by rx₃ is reduced in magnitude during chip1 by a proximate interfering object, so that the amplitude of the phasor is reduced and the phase of the phasor is changed from a 45 degree position to a position of about 50 degrees, wherein 0 degrees is the horizontal axis extending to the right, 90 degrees is the vertical axis extending up, 180 degrees is the horizontal axis extending to the left, and 270 degrees is the vertical axis extending down.

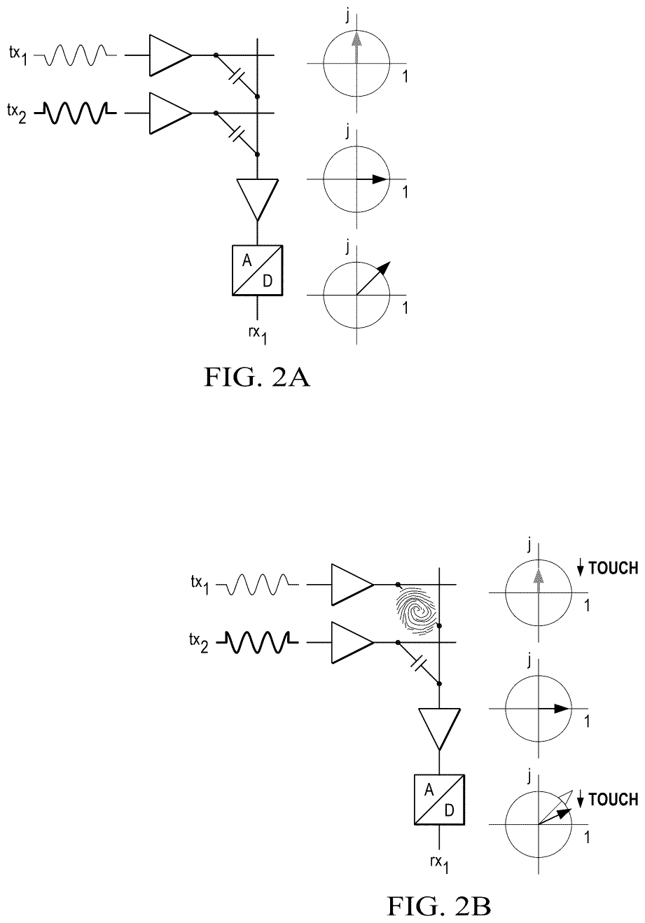

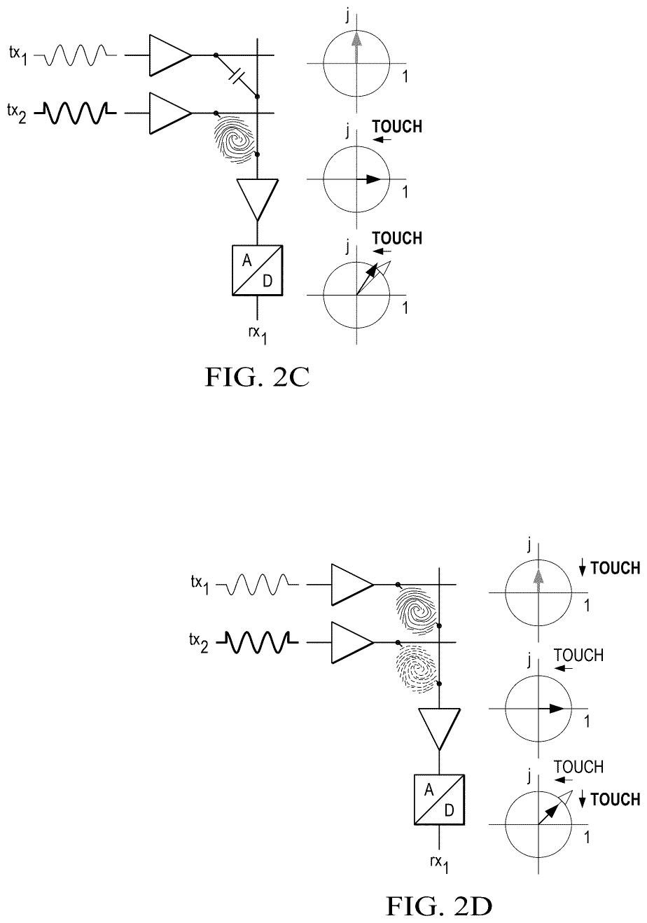

FIGS. 2A through 2D show quadrature TX superposition.

FIG. 2A shows a sinusoidal transmit signal driving transmit electrodes tx₁ and tx₂ with a phase shift of 90 degrees between the sinusoidal transmit signals so the signals are in quadrature. There are no interferences at the mutual capacitance nodes where the transmit electrodes tx₁ and tx₂ intersect with the receive electrode rx₁. The component signal of the phasor received from tx₁ has amplitude equal to one (1) and phase of ninety (90) degrees, and the component signal of the phasor received from tx₂ has amplitude equal to one (1) and phase of zero (0) degrees. Thus, the phasor of the signal received by rx₁ has amplitude equal to 1.4142 (square root of 2) and phase of forty-five (45) degrees.

FIG. 2B shows a sinusoidal transmit signal driving transmit electrodes tx₁ and tx₂ with a phase shift of 90 degrees between the sinusoidal transmit signals so the signals are in quadrature. There is an interference at the mutual capacitance node where the transmit electrode tx₁ intersects with the receive electrode rx₁. The component signal of the phasor received from tx₁ has amplitude equal to seven tenths (0.7) and phase of ninety (90) degrees, and the component signal of the phasor received from tx₂ has amplitude equal to one (1) and phase of zero (0) degrees. Thus, the phasor of the signal received by rx₁ has amplitude equal to 1.22 (square root of 1.49) and phase of thirty-five (35) degrees. For comparison, the phasor with amplitude equal to 1.4142 and phase of forty-five (45) degrees is shown as a grey arrow.

FIG. 2C shows a sinusoidal transmit signal driving transmit electrodes tx₁ and tx₂ with a phase shift of 90 degrees between the sinusoidal transmit signals so the signals are in quadrature. There is an interference at the mutual capacitance node where the transmit electrode tx₂ intersects with the receive electrode rx₁. The component signal of the phasor received from tx₁ has amplitude equal to one (1) and phase of ninety (90) degrees, and the component signal of the phasor received from tx₂ has amplitude equal to seven tenths (0.7) and phase of zero (0) degrees. Thus, the phasor of the signal received by rx₁ has amplitude equal to 1.22 (square root of 1.49) and phase of fifty-five (55) degrees. For comparison, the phasor with amplitude equal to 1.4142 and phase of forty-five (45) degrees is shown as a grey arrow.

FIG. 2D shows a sinusoidal transmit signal driving transmit electrodes tx₁ and tx₂ with a phase shift of 90 degrees so the signals are in quadrature. There is an interference at the mutual capacitance node where the transmit electrode tx₁ intersects with the receive electrode rx₁ and an interference at the mutual capacitance node where the transmit electrode tx₂ intersects with the receive electrode rx₁. The component signal of the phasor received from tx₁ has amplitude equal to seven tenths (0.7) and phase of ninety (90) degrees, and the component signal of the phasor received from tx₂ has amplitude equal to seven tenths (0.7) and phase of zero (0) degrees. Thus, the phasor of the signal received by rx₁ has amplitude equal to one (1) (square root of 1.0) and phase of forty-five (45) degrees. For comparison, the phasor with amplitude equal to 1.4142 and phase of forty-five (45) degrees is shown as a grey arrow. As can be seen, the phasor of the signal received by rx₁ has a reduced amplitude as compared with the phasor of FIG. 2A.

The quadrature TX superposition may provide unambiguous interfering object positions. The quadrature TX superposition may allow to double the number of TX signals, i.e. electrodes, to be transmitted and measured simultaneously, while the SNR remains unchanged, compared to CDMA.

According to aspects, orthogonality of signals at the receiver electrode provides independence between different, superposed transmit signals, where it would otherwise be difficult to dissect the sum received signal into its components. While for signals orthogonal in time or code space, a guard interval can prevent such inter-channel interference, this may not work for transmit signals in quadrature, i.e., orthogonal in complex space, when experiencing different signal propagation delays.

Differences in signal propagation delay may be resolved by: (1) at the transmitter, adjusting the transmit signal phases or delays such that the two transmit signals at hand arrive at the receiver in quadrature (which may be considered a software solution: e.g., by transmit phase control); (2) on the channels, by ensuring that the propagation delay of two transmit signals in quadrature is approximately equal (which may be considered a hardware solution: e.g., by sensor layout, e.g., by adjusting feeding line lengths), or (3) algorithmically, by assigning quadrature space-time mapping vectors to a pair of transmit electrodes with approximately the same propagation delay to a receiver. Regarding this third propagation delay resolution method, dedicated space-time-map-to-Tx assignments provide independence between any transmit signals, and is achievable for a variety of sensor setups.

Multiplexing is a method of transmitting and receiving independent signals over a common channel, i.e., a common signal path for multiple transmit signals to a receiver. Signal independence can be yielded, for example, using time-division, frequency division, code division, or signal quadrature. To yield a desired receive signal phase (and, optionally, also signal amplitude), the received signal can be corrected in phase (and amplitude) in a so-called equalization step. Because all transmit signals share one single channel, one phase (and one amplitude) correction value may be considered.

With multiple-access systems, the different transmit signals can have individual channels to a receiver. Therefore, channel phase and attenuation should be corrected for each transmit signal with individual correction values (to adjust the Rx phase). Inter-symbol interference (ISI) due to mismatch of expected and actual receive sequence (symbol) boundaries (start/end) at the receiver, e.g., due to different signal propagation delays, can be explicitly suppressed with a so-called guard interval, or implicitly—for example—by using a low-pass filter function suppressing the first and/or last samples of a receive signal sequence. To avoid inter-channel (inter-Tx) interference, signal orthogonality may be imposed at the receiver.

For time-division and code-division signals, i.e., transmit signal orthogonal in time and/or in the code space, orthogonality can be achieved despite differences between signal propagation delays for the different transmit signals also by using a sufficiently long guard interval.

A transmit electrode TX matrix stack may allow manipulations, including: rows reordered, any row multiplied by a constant, real-valued factor, columns reordered, any column multiplied by a complex number. Matrices can be manipulated before being stacked in a theta matrix θ, and the theta matrix θ can be further manipulated, where

$$j = \sqrt{- 1}$$

$$Θ = [ \begin{matrix}{H}_{n} \\ {jH}_{n}\end{matrix} ]$$

where Hₙ is an orthogonal matrix of order n; for example, a Hadamard matrix, and

$$theta matrix Θ = [ \begin{matrix}{H}_{n} \\ {jP}_{n}\end{matrix} ]$$

where Hₙ and Pₙ are two orthogonal matrices of order n but are not necessarily identical or equivalent. For example, a Hadamard matrix and a Paley type I matrix. Equivalent in this context means Pₙ can be obtained from Hₙ by linear combinations of its rows.

When a column of the Tx matrix stack is manipulated, the inverse operation should be performed on the receiver side before further processing of the respective chip, like, e.g., CDMA decoding.

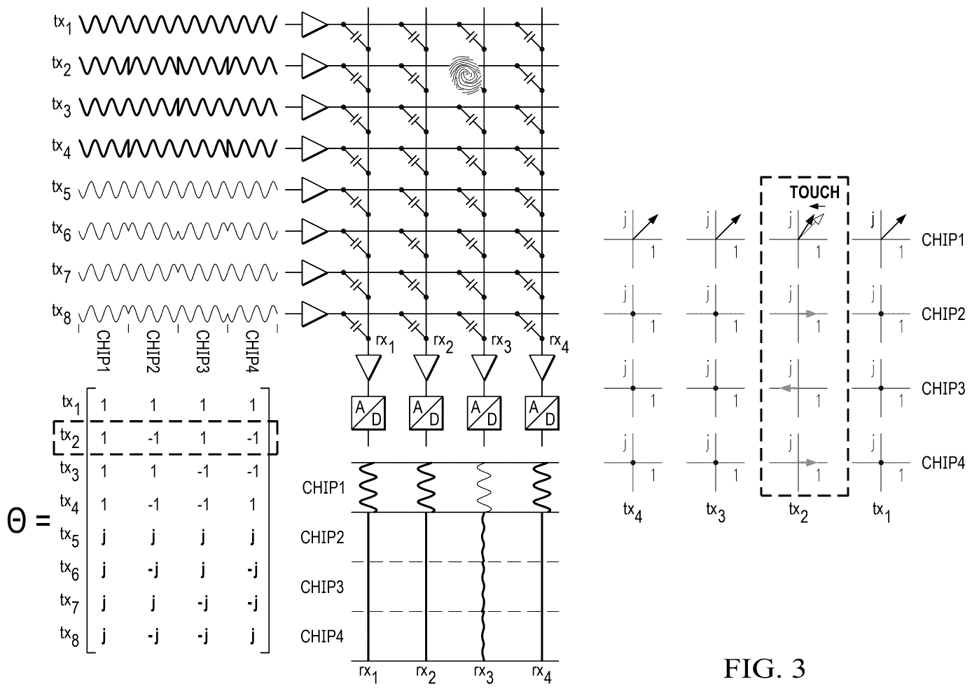

FIG. 3 shows how two different forms of orthogonality may be combined (QM+CDMA=QCDMA). The transmit signals of tx₁-tx₄ are phase shifted by 90 degrees relative to the transmit signals of tx₅-tx₈. An orthogonal code may be used for CDMA extra-chip modulation, where quadrature modulation may happen within a chip (intra) or at the transition between chips (extra). A superposed TX signal, owing to orthogonality, may be brought by quadrature intra-chip modulation, where modulation may happen within a chip (intra) or at the transition between chips (extra). CDMA may be decoded as measured I/Q vectors instead of scalars. In the example shown in FIG. 3, the phasors received at the receive electrodes during a first chip are decoded by CDMA to determine the mutual capacitance node tx₂/rx₃ is being interfered,

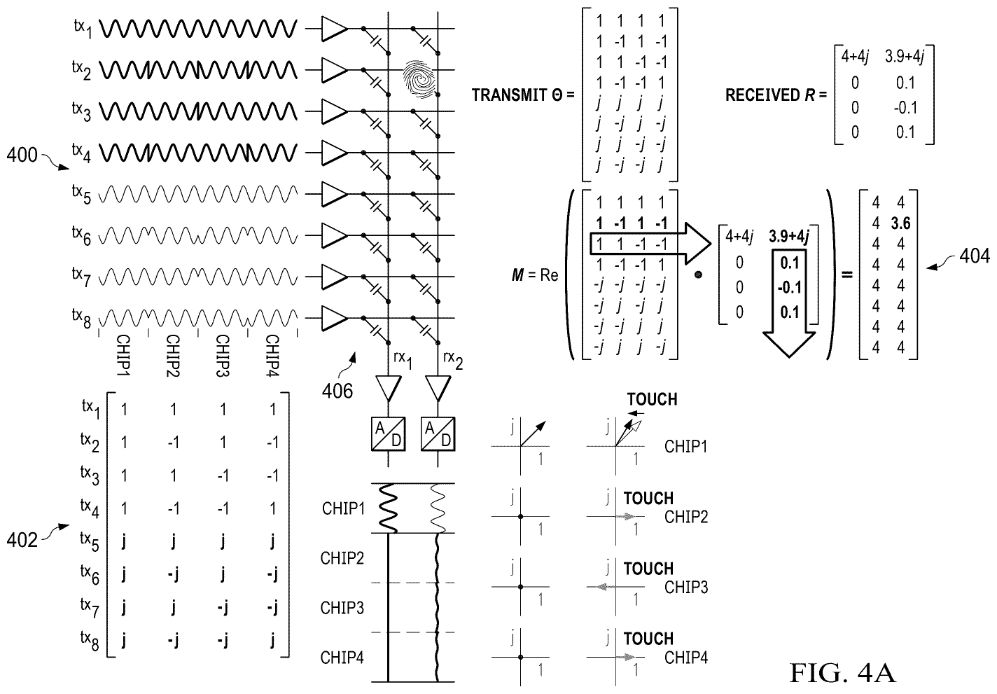

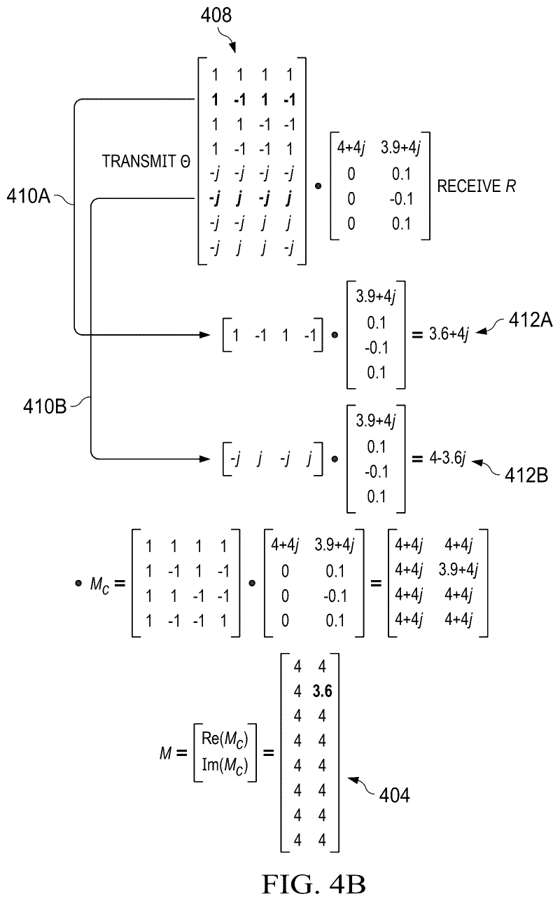

FIG. 4A shows a general case of QCDMA decoding, where the matrix of received chips, R, contains complex numbers. In the signal matrix 400 shown adjacent transmit electrodes tx1-tx8, the columns are chip time intervals, and the rows transmit electrodes, A numerical matrix 402 corresponds to the signal matrix 400. The decoding uses the complex conjugate of theta matrix θ, so that the correlation of an imaginary number with itself yields a positive result. An alternative is to use the complex conjugate of R instead. There is redundancy when computing θ̅·R: half θ rows are copies of other rows, oriented along the imaginary (j) axis. For example, the row for tx₈ and the row for tx₄ are related. Therefore, it is possible to compute M_{c}, wherein M_{c} is a map of real and imaginary components of their respective positions that may be used to recreate an expected 8×2 matrix (M) for mutual capacitance. The transmit signal matrix θ is multiplied by the receive signal matrix R to produce the mutual capacitance node matrix 404. The mutual capacitance node matrix 404 corresponds to the mutual capacitance nodes 406 comprising transmit electrodes tx₁-tx₈ and receive electrodes rx₁-rx₂, wherein all of the mutual capacitance nodes have a measured signal value of 4, except for the mutual capacitance node corresponding to tx₂/rx₂, which has a measured signal value of 3.6 indicating an interference.

FIG. 4B shows an alternative case of QM decoding. When a single “combined CDMA code” is used, one receiver computes one phasor per chip, wherein a phasor may be a scalar complex number. The sequence of received chips is decoded by computing vectorial dot products. Because two rows of theta matrix 408 differ by a factor j, the vector dot product of the second rows may not be computed as is done in the “generalized decoding” described with reference to FIG. 4A. When two independent codes 410A and 410B are used, the receivers compute two sets of chip phasors 412A and 412B. Each set is decoded independently as complex scalars. Phasor changes (3.9+4j) in the major direction (due to the QPSK code set) are used, and phasor deviation (4+4j) in the perpendicular directions (due to the other CDMA code set) are ignored. Signals 410A and 410B from transmit signal matrix Θ are multiplied by the major direction receive signal matrix R to produce phasors 412A and 412B. As noted, the real component of phasor 412A used to produce the mutual capacitance node matrix 404, corresponds to the mutual capacitance nodes 406 comprising transmit electrodes tx₁-tx₈ and receive electrodes rx₁-rx₂, wherein all of the mutual capacitance nodes have a measured signal value of 4, except for the mutual capacitance node corresponding to tx₂/rx₂, which has a measured signal value of 3.6 indicating an interference. See FIG. 4A. Whether the system operates as a single combined code or as two independent codes, if chip lengths are uneven then an additional processing is desired: either the template coefficients or the resulting phasor before CMDA decoding is normalized by the gain tied to the chip length.

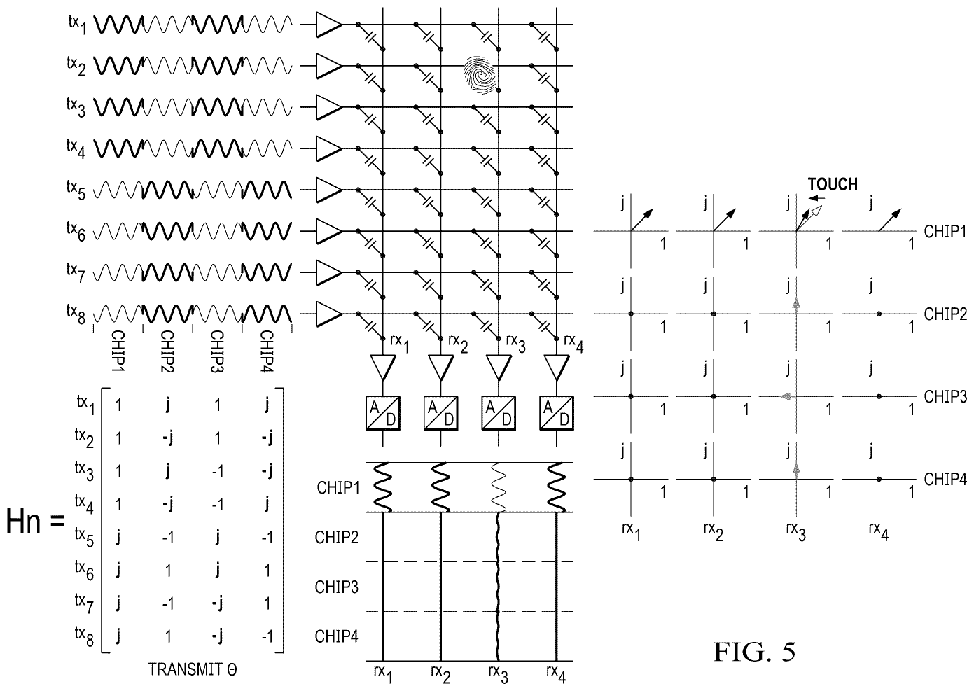

FIG. 5 shows code variations, wherein transmit signals of tx-tx: of the code matrix are swapped with transmit signals of tx₅-tx₈ during chip 2 and chip 4. In other examples, rows of the code matrix can be reordered, rows of the code matrix can be omitted, rows of the code matrix can be multiplied by −1 (but typically not by j, because it then would look like another row of the matrix and therefore not be orthogonal), columns of the code matrix can be multiplied by a unity vector of arbitrary phase, two columns of the code matrix can be swapped, and code matrices can be changed between two measurement frames.

As shown in FIG. 5 the chip boundaries are the same for all used transmit electrodes, and the receivers compute one phasor at a time. An orthogonal matrix Hn is built and constitutes the CDMA code. Rows of the matrix correspond to the sequency of chips applied to the transmit electrodes (for example+1 for 0° phase, −1 for 180′ phase). A taller matrix theta θ (not shown) may be created by vertically concatenating two, possibly different, orthogonal matrices Hn0 and j*Hn1 to produce a matrix theta (Transmit Θ). The resulting second matrix sits on the imaginary axis, since j=sgrt(−1). Matrix theta (Transmit Θ) can be further transformed with row permutations, column permutations, or multiplication of rows by −1 or multiplication of columns by j or −j. The content of the theta matrix (Transmit Θ) is then mapped to selection of transmission waveforms picked from their respective transmission groups and respective polarity.

TX waveforms may have the following properties.

I=(t)=cos(f(t))

Q(t) sin(f(t)), where f(t) is a function which provides the instantaneous phase. For example f(t)=2*pi*fc*t for a linear phase increase I(t) and Q(t) can then be further modified by adding a constant, inserting a threshold, or multiplying with an envelope function to control spectral leakage.

For two transmitters transmitting signals in quadrature over channels with different signal propagation delays to a receiver, orthogonality may be achieved in the superimposed received signal by assigning pairs of space-time maps which are in quadrature to electrodes with same or similar propagation delays.

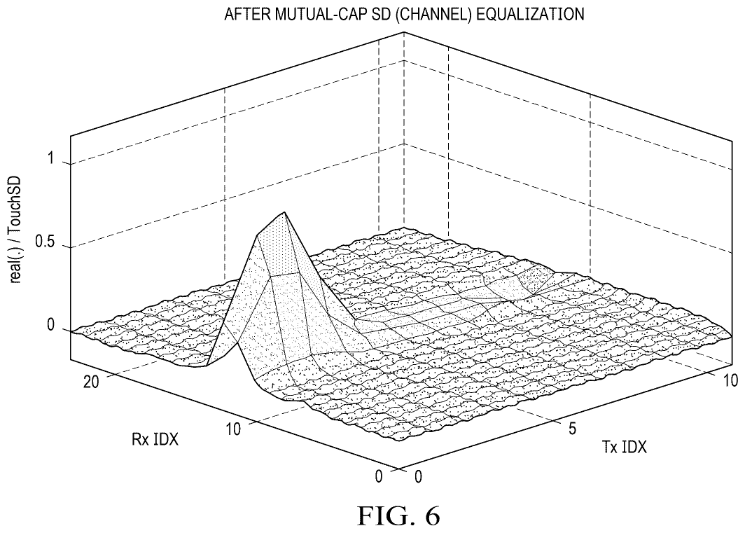

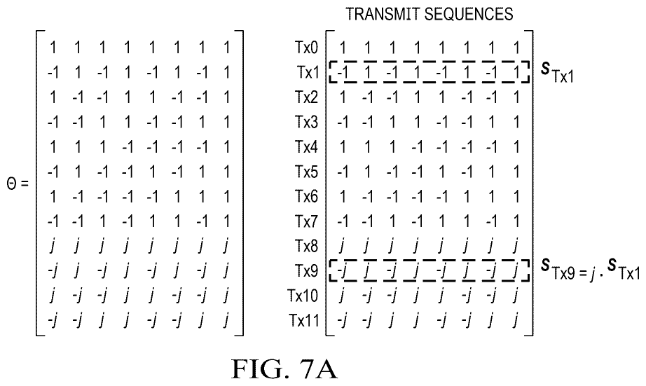

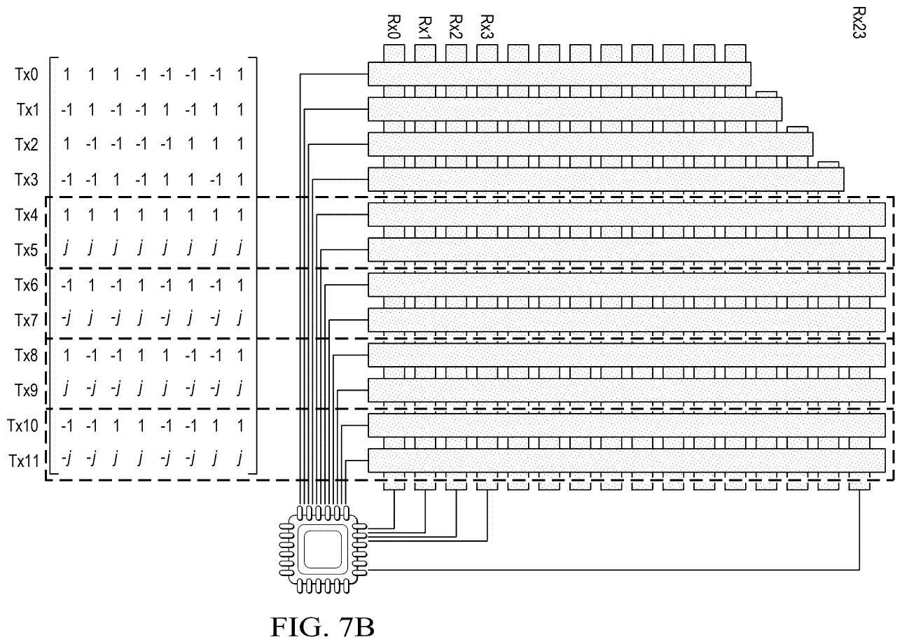

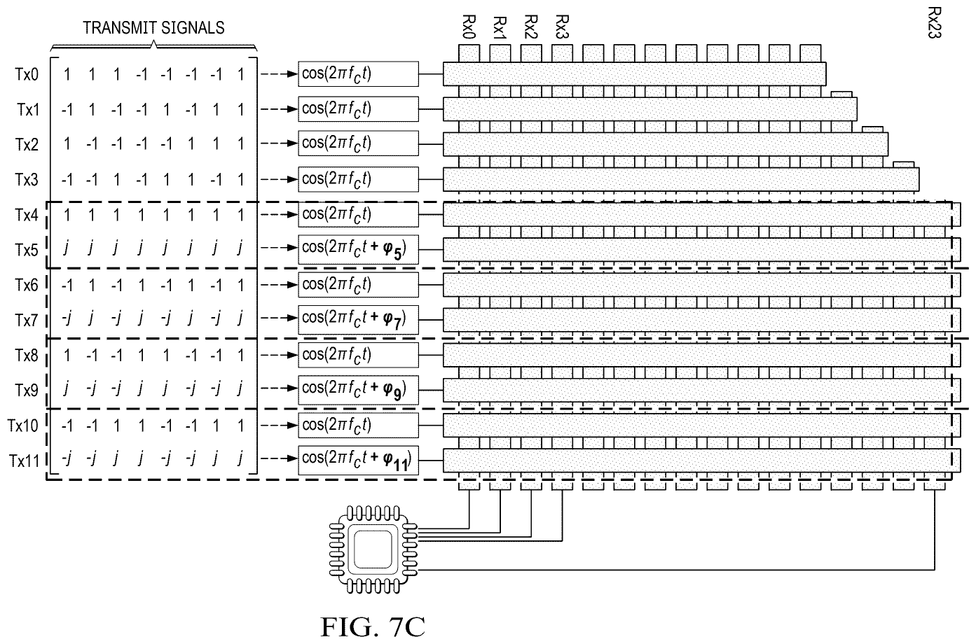

FIG. 6 shows a plot of a touch level estimate matrix obtained using the space-time mapping matrix shown in FIG. 7A, with each Tx a row and each time slot a column. FIG. 7A shows a quadrature transmit electrode pair, which is a set of two transmit electrodes to which the same binary code word is assigned but with a 90 degree phase shift between the two. As illustrated in FIG. 7A, Tx1 and Tx9 are assigned the same binary code word (−1, 1, −1, 1, −1, 1, −1, 1), but Tx9 is shifted 90 degrees from Tx1 (S_{Tx9}=j×S_{Tx1}). Rows #8-#11 are 90-degree shifted versions of rows #0-#3, respectively. For example, the space-time maps for Tx #2 and Tx #10 are in quadrature, at the transmitters. However, because transmit electrodes Tx #2 and Tx #10 are relatively distant from each other on the touch sensor, i.e., the lengths of their feeding lines are relatively distant (not shown in FIG. 7A), different channel delays (signal propagation delays) result in loss of quadrature at the receiver, and thus inter-channel interference. This inter-channel interference may be overcome by assigning pairs of space-time maps which are in quadrature to electrodes with same or similar channel or propagation delays. Typically, neighboring transmit electrodes may have similar signal propagation delays and may be paired based on them having similar signal propagation delays. Signal propagation delays may remain substantially constant over time, or signal propagation delays may change over time.

FIG. 7B shows code word assignments for transmit electrodes of a capacitive touch sensing system comprising transmit electrodes and receive electrodes positioned to have mutual capacitances between the transmit electrodes and the receive electrodes at mutual capacitance nodes, wherein the mutual capacitance at a mutual capacitance node deviates when an interfering object is proximate. There are four Tx electrode pairs with code words in quadrature. The two electrodes of each of these pairs are located next to each other, to reduce the expected signal propagation delay. Further, Tx0, Tx1, Tx2 and Tx3 are not part of a Tx electrode pair, because their length is distinctively different from the length of Tx4-Tx11, which is why different signal propagation delays may be expected for them too. Transmit signals in quadrature may have approximately the same signal propagation delay to the receiver by: (1) mapping via a software configuration the pairing of transmit electrodes with the same channel or phase delay, or (2) hardware modifying a sensor layout so that transmit electrodes pairs have the same channel or propagation delay. FIG. 7B shows Tx4 and Tx5 are assigned the same binary code word (1, 1, 1, 1, 1, 1, 1, 1), but Tx5 is shifted 90 degrees from Tx4 (S_{Tx5}=j×S_{Tx4}). Tx6 and Tx7 are assigned the same binary code word (−1, 1, −1, 1, −1, 1, −1, 1), but Tx7 is shifted 90 degrees from Tx6 (S_{Tx7}=j×S_{Tx6}). Tx8 and Tx9 are assigned the same binary code word (1, −1, −1, 1, 1, −1, −1, 1), but Tx9 is shifted 90 degrees from Tx8 (S_{Tx9}=j×S_{Tx8}). Tx10 and Tx11 are assigned the same binary code word (−1, −1, 1, 1, −1, −1, 1, 1), but Tx11 is shifted 90 degrees from Tx10 (S_{Tx11}=j×S_{Tx10}).

FIG. 7C shows the code word assignments shown in FIG. 7B, and further shows that transmit signal phase may be used to compensate for the two channels' propagation delay difference, by means of ‘tuning’ phases φ₅, φ₇, φ₉, φ₁₁.

In an alternative example not illustrated, configurable phases are used to implement the 90, 180, 270 degree phase shifts of QCDMA. QM by itself, i.e., without CDM/CDMA, may make 0-degree or 90-degree phase shifts and not others.

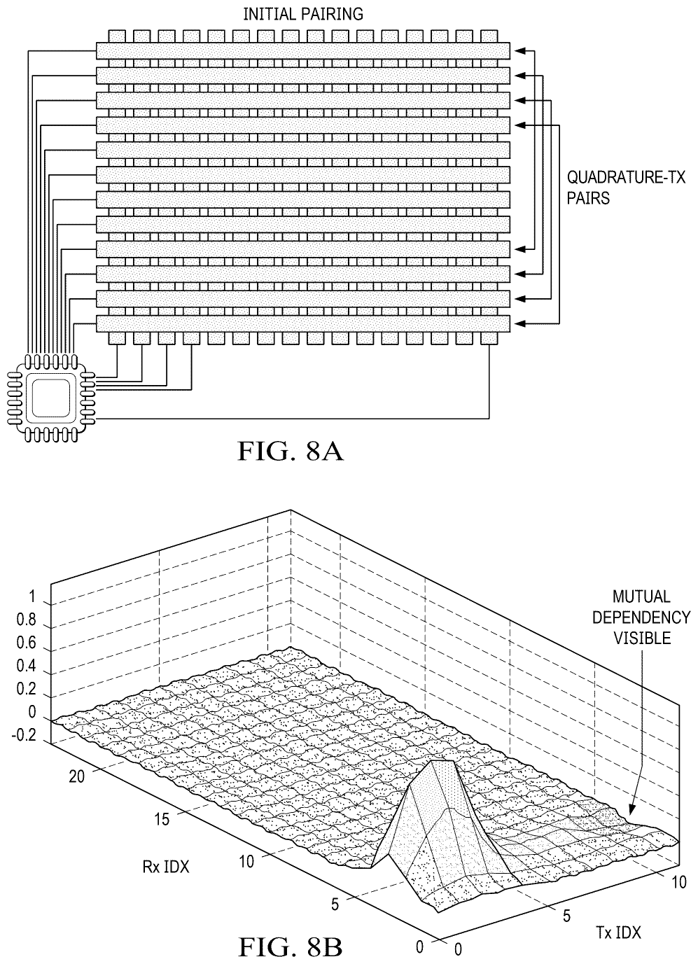

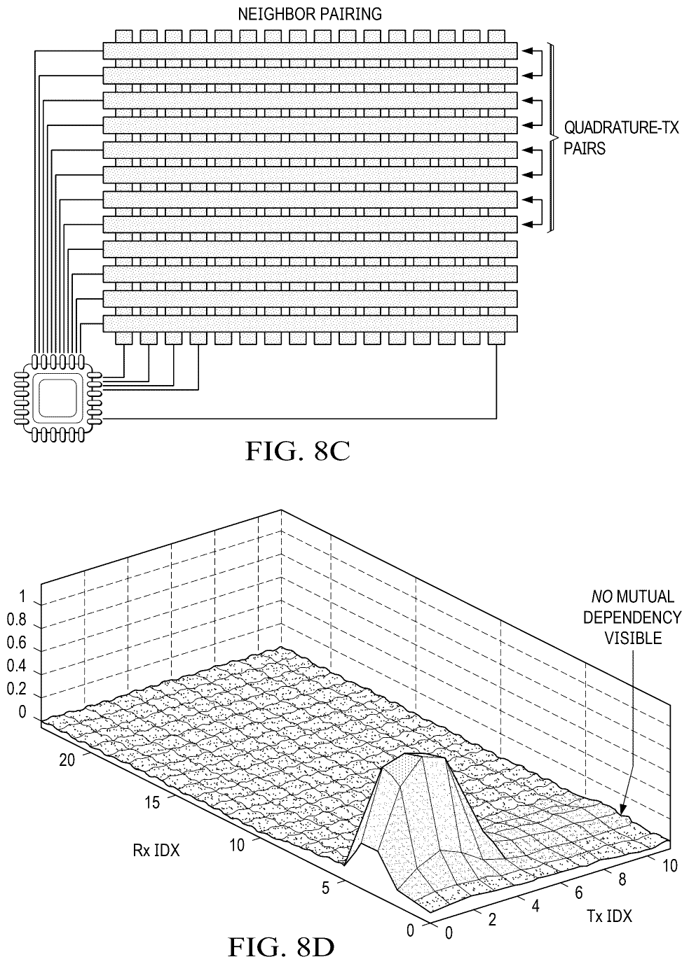

FIGS. 8A and 8C show capacitive touch sensing systems, comprising transmit electrodes and receive electrodes, and FIGS. 8B and 8D are graphs showing received signals where an interfering object is proximate the same mutual capacitance node in both systems. The received signal graph shown in FIG. 8B corresponds to the system of FIG. 8A, and the received signal graph shown in FIG. 8C corresponds to the system of FIG. 8D. In FIG. 8A, the quadrature transmit electrode pairs are not adjacent to each other, and therefore have different propagation delays for the signals from the transmitters to the receivers. The graph of FIG. 8B shows a mutual dependency or a false touch is visible or present in the received signal. In FIG. 8C, the quadrature transmit electrode pairs are adjacent to each other, and therefore have similar propagation delays for the signals from the transmitters to the receivers. The graph of FIG. 8D shows no mutual dependency or false touch is visible or present in the received signal. When the electrodes of quadrature transmit pairs are not adjacent to each other, a mutual dependency may be introduced in the receive signal. When the electrodes of quadrature transmit pair are adjacent or neighboring, a mutual dependency may be avoided and thus not introduced in the receive signal.

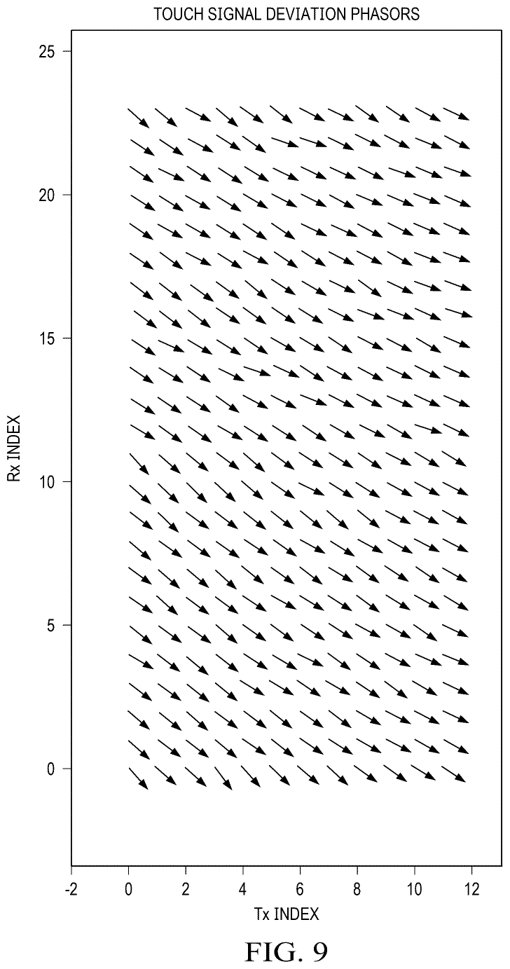

FIG. 9 shows, for each mutual capacitance node, the signal deviation when a reference interfering object is proximate. The phasor angles differ, which is, amongst other reasons, caused by different lengths of electrode connection lines, so-called ‘feeding lines’. Two Tx signals in phase-quadrature may be assigned to two Tx electrodes with approximately the same phasor angle for each receive electrode. The phasor angles for Tx Electrode #5 differ distinctively from those for Tx Electrode #0. Therefore, Tx electrodes #5 and #0 are not ideally suitable for assigning a pair of phase-quadrature Tx signals. However, the phasor angles for Tx electrode #1 are very similar to those of #0, for which reason Tx electrodes #0 and #1 are a more suitable pair for quadrature-phase Tx signals. Row 0 and Row 8 of the space-time-mapping matrix may be assigned as space-time mapping vectors to Tx electrodes #0 and #1, respectively.

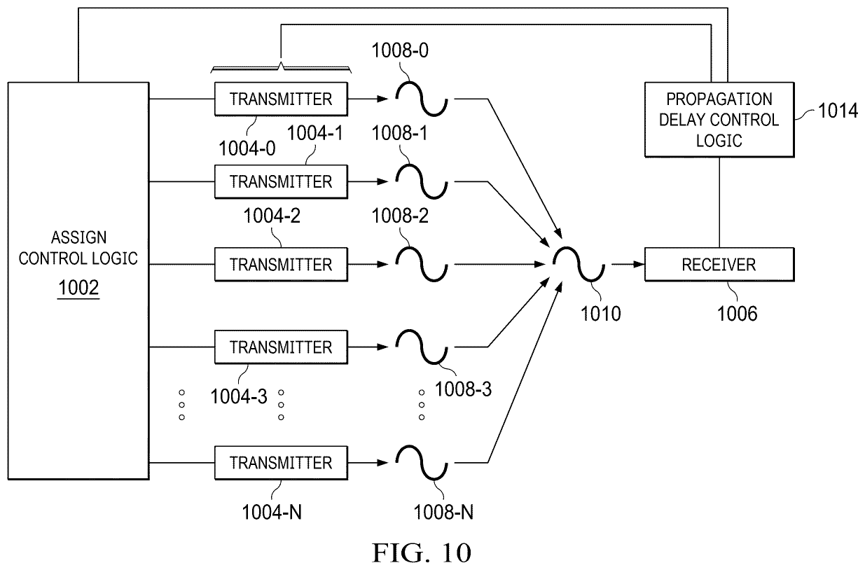

FIG. 10 shows a block diagram of a system comprising a plurality of transmitters (1004-0-1004-N) to simultaneously transmit a plurality of transmit signals, one transmit signal per transmitter respectively; assign control logic 1002 to assign a first transmit signal to a first transmitter and a second transmit signal to a second transmitter, and so forth; and a receiver 1006 to receive a superimposed receive signal comprising a plurality of receive signal components which originate from the plurality of transmit signals, respectively, wherein a first receive signal component of the superimposed receive signal to originate from the first transmitter and a second receive signal component of the superimposed signal to originate from the second transmitter are to be in quadrature. A propagation delay control logic 1014 may measure the signal propagation delay for individual transmit signals (1008-0 through 1008-N) and provide the measured propagation delays to the assign control logic 1002. The propagation delay control logic 1014 may measure a first signal propagation delay and a second signal propagation delay without mutual capacitances at mutual capacitance nodes being deviated by a proximate interfering object. The propagation delay control logic 1014 may measure a first signal propagation delay and a second signal propagation delay with a mutual capacitance at a mutual capacitance node being deviated by a proximate interfering object. Further, as an example, first and second transmitters may have associated first and second signal propagation delays, respectively. Assign control logic 1002 assigns transmit signals to transmitters based on measured signal propagation delays provided by the propagation delay control logic 1014. For example, a first transmitter and a second transmitter may be paired by assignment of transmit signals based on the first signal propagation delay and the second signal propagation delay. The first transmitter and the second transmitter may be paired based on the first signal propagation delay and the second signal propagation delay being more similar to each other than either compared to another signal propagation delay.

One aspect provides sequentially ordering transmitters in a list according to the propagation delays of signals transmitted from the transmitters to a receiver. For example, the transmitters shown in FIG. 7C may be ordered Tx0 through Tx11 because Tx0 has the shortest propagation delay and Tx11 has the longest propagation delay. The transmitters may be paired by sequentially pairing consecutive transmitters in the list: Tx4 and Tx5; Tx6 and Tx7; Tx8 and Tx9; Tx10 and Tx11, wherein each pair is assigned two Tx signals in quadrature.

As shown in FIG. 10, a system may comprise: a plurality of transmitters (1004-0 through 1004-N) to simultaneously transmit a plurality of transmit signals (1008-0 through 1008-N), one transmit signal per transmitter respectively; assign control logic 1002 to assign a first transmit signal 1008-0 to a first transmitter 1004-0 and a second transmit signal 1008-1 to a second transmitter 1004-1; and a receiver 1006 to receive a superimposed receive signal 1010 comprising a plurality of receive signal components to originate from the plurality of transmit signals (1008-0 through 1008-N), respectively, wherein a first receive signal component of the superimposed receive signal 1010 to originate from the first transmitter 1004-0 and a second receive signal component of the superimposed receive signal 1010 to originate from the second transmitter 1004-1 are to be in quadrature, wherein the plurality of receive signal components are to be delayed relative to a plurality of signal propagation delays, respectively, wherein the plurality of transmitters (1004-0 through 1004-N) are ordered according to respective propagation delays (1008-0 is the fastest and 1008-N is the slowest); and wherein respective twos (1004-0 and 1004-1; 1004-2 and 1004-3; . . . ) of the plurality of transmitters are paired sequentially in order of signal propagation delay.

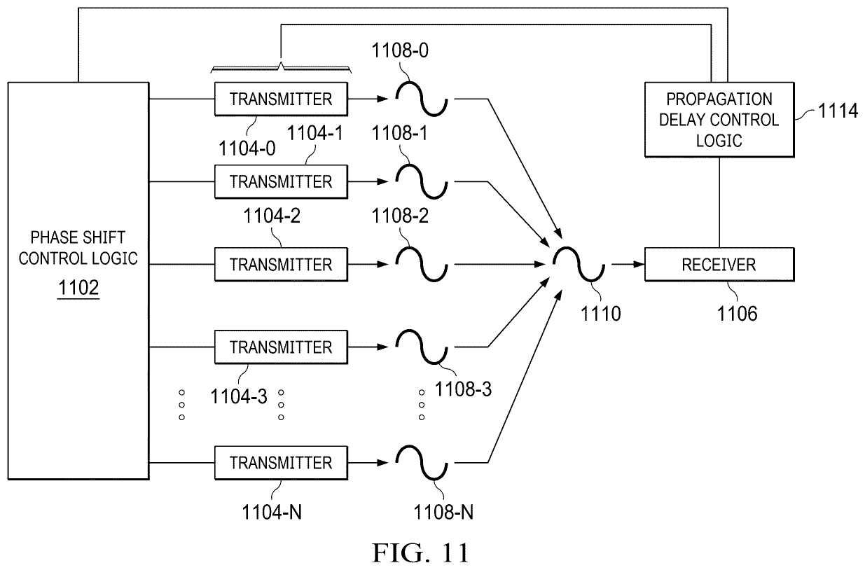

FIG. 11 shows a block diagram of a system comprising a plurality of transmitters (1104-0-1104-N) to simultaneously transmit a plurality of transmit signals, one transmit signal per transmitter respectively; phase shift control logic 1102 to shift a first transmit signal 1108-0 and a second transmit signal 1108-1; and a receiver 1106 to receive a superimposed receive signal comprising a plurality of receive signal components to originate from the plurality of transmit signals (1108-0 through 1108-N), respectively, wherein the phase shift control logic 1202 shifts individual transmit signals (1108-0 through 1108-N) in view of respective signal propagation delay so that paired transmit signals arrive at the receiver 1106 in quadrature. For example, transmit signal 1108-1 may have a longer propagation delay than transmit signal 1108-3, but transmitters 1104-1 and 1104-3 may be a quadrature pair because the phase shift control logic 1102 shifts one or both of the transmit signals 1108-1 and 1108-3 so that they both arrive at the receiver 1106 in quadrature. A propagation delay control logic 1114 may measure the signal propagation delay for individual transmit signals (1108-0 through 1108-N) and provide the measured signal propagation delays to the phase shift control logic 1102. Phase shift control logic 1102 shifts transmit signals of individual transmitters based on measured signal propagation delays provided by the propagation delay control logic 1114.

Assign control logic 1002, phase shift control logic 1102, and propagation delay control logic 1014 and 1114 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control logic may be implemented by instructions for execution by a processor through, for example, a function, application programming interface (API) call, script, program, compiled code, interpreted code, binary, executable, executable file, firmware, object file, container, assembly code, or object. For example, control logic may be implemented by instructions stored in a non-transitory medium such as a memory that, when loaded and executed by a processor such as CPU (or any other suitable process), cause the functionality of control logic described herein.

Some aspects may employ both an assign control logic 1002 (FIG. 10) to assign transmit signals to transmitters based on propagation delay and a phase shift control logic 1102 (FIG. 11) to phase shift signals based on propagation delay. In some aspects the signal propagation delays remain substantially constant over time. In other aspects, the propagation delays change over time and the transmitter assignments or the phase shifts are updated based on measured propagation delays over time.

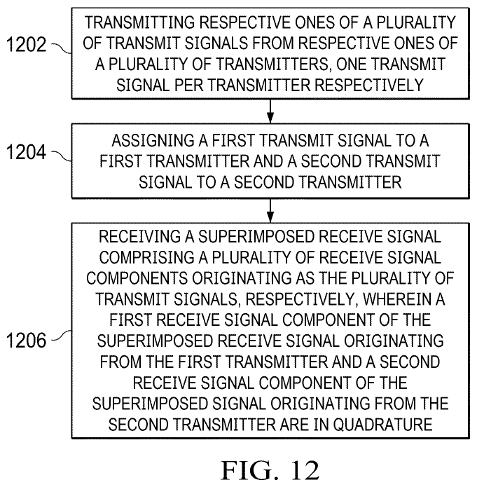

FIG. 12 shows a flow chart of a method. Respective ones of a plurality of transmit signals are transmitted 1202 from respective ones of a plurality of transmitters, one transmit signal per transmitter respectively. A first transmit signal is assigned 1204 to a first transmitter and a second transmit signal is assigned 1204 to a second transmitter. A superimposed receive signal is received 1206 comprising a plurality of receive signal components originating as the plurality of transmit signals, respectively, wherein a first receive signal component of the superimposed receive signal originating from the first transmitter and a second receive signal component of the superimposed signal originating from the second transmitter are in quadrature.

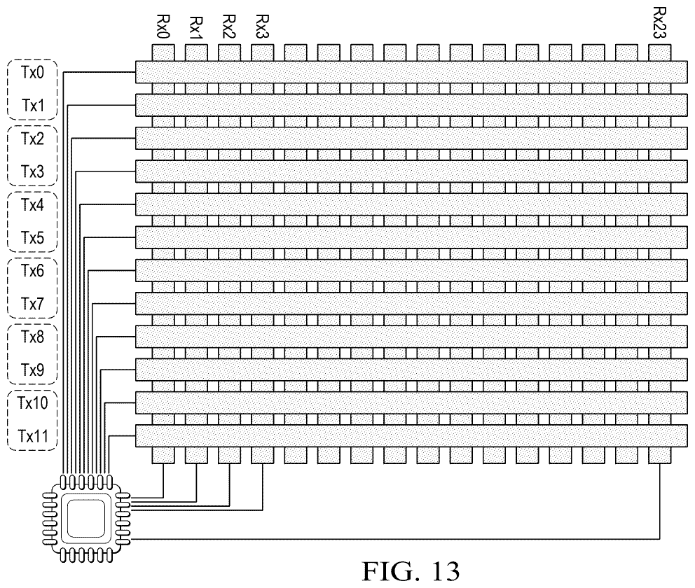

FIG. 13 shows a capacitive touch sensing system, comprising transmit electrodes positioned horizontally and receive electrodes positioned vertically. A non-transitory computer-readable storage medium comprising software code adapted, when executed on a data processing apparatus, assigns transmit signals to transmitters so received signal components are in quadrature. The software code assigns a first transmit signal to transmitter Tx0 and a second transmit signal to transmitter Tx1, so that a receiver receives a superimposed receive signal comprising a plurality of receive signal components originating from the first and second transmit signals, respectively, wherein a first receive signal component of the superimposed receive signal originating from the transmitter Tx0 and a second receive signal component of the superimposed receive signal originating from the transmitter Tx1 are in quadrature. The software code further assigns transmit signals to transmitters Tx2 and Tx3 so received signal components are in quadrature. Transmit signals are assigned to the remaining pairs of transmitters so received signal components are in quadrature. The software code further assigns transmit signals to transmitters pairs: Tx4 and Tx5; Tx6 and Tx7; Tx8 and Tx9; and Tx10 and Tx11, so received signal components are in quadrature

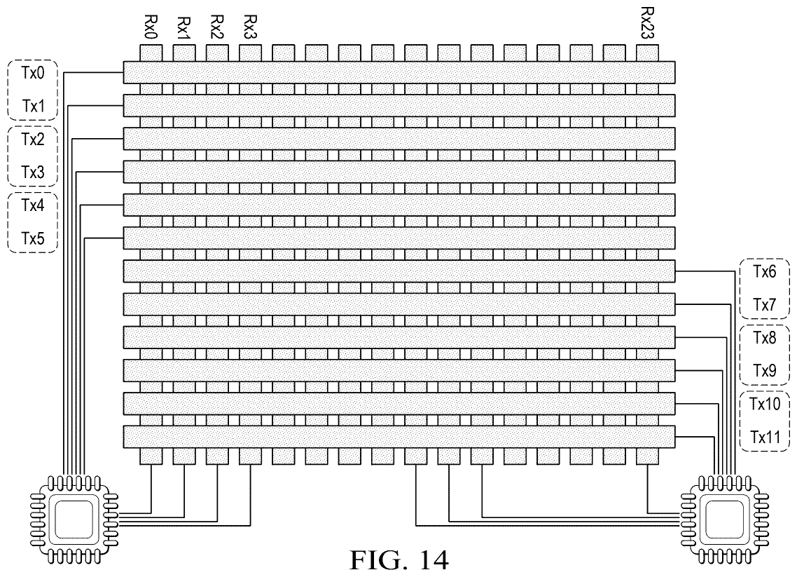

FIG. 14 shows a capacitive touch sensing system, comprising transmit electrodes positioned horizontally and receive electrodes positioned vertically. A non-transitory computer-readable storage medium comprising software code adapted, when executed on a data processing apparatus, assigns transmit signals to transmitters so received signal components are in quadrature. The software code assigns a first transmit signal to transmitter Tx0 and a second transmit signal to transmitter Tx1, so that a receiver receives a superimposed receive signal comprising a plurality of receive signal components originating from the first and second transmit signals, respectively, wherein a first receive signal component of the superimposed receive signal originating from the transmitter Tx0 and a second receive signal component of the superimposed receive signal originating from the transmitter Tx1 are in quadrature. The software code further assigns transmit signals to transmitters pairs: Tx2 and Tx3; Tx4 and Tx5; Tx6 and Tx7; Tx8 and Tx9; and Tx10 and Tx11, so received signal components are in quadrature.

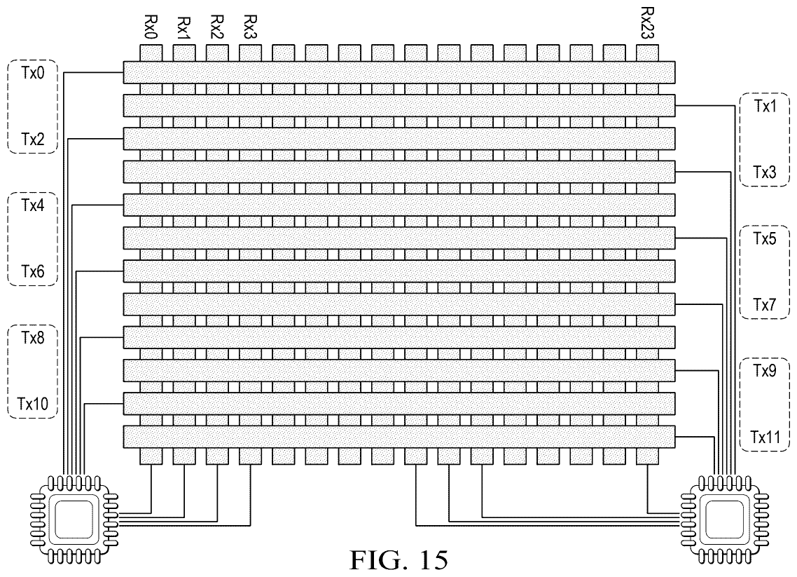

FIG. 15 shows a capacitive touch sensing system, comprising transmit electrodes positioned horizontally and receive electrodes positioned vertically. A non-transitory computer-readable storage medium comprising software code adapted, when executed on a data processing apparatus, assigns transmit signals to transmitters so received signal components are in quadrature. The software code assigns a first transmit signal to transmitter Tx0 and a second transmit signal to transmitter Tx2, so that a receiver receives a superimposed receive signal comprising a plurality of receive signal components originating from the first and second transmit signals, respectively, wherein a first receive signal component of the superimposed receive signal originating from the transmitter Tx0 and a second receive signal component of the superimposed receive signal originating from the transmitter Tx2 are in quadrature. The software code further assigns transmit signals to transmitters pairs: Tx1 and Tx3; Tx4 and Tx6; Tx5 and Tx7; Tx8 and Tx10; and Tx9 and Tx11, so received signal components are in quadrature.

In the capacitive touch sensing systems shown in FIGS. 13-15, the assignments of transmit signals to transmitters may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. The assignments of transmit signals to transmitters may be implemented by instructions for execution by a processor through, for example, a function, application programming interface (API) call, script, program, compiled code, interpreted code, binary, executable, executable file, firmware, object file, container, assembly code, or object. For example, the assignments of transmit signals to transmitters may be implemented by instructions stored in a non-transitory medium such as a memory that, when loaded and executed by a processor (or any other suitable process), cause the assignment functionality described herein.

Although examples have been described above, other variations and examples may be made from this disclosure without departing from the spirit and scope of these disclosed examples.

1. A system comprising:
a plurality of transmitters to simultaneously transmit a plurality of transmit signals, one transmit signal per transmitter respectively;
assign control logic to assign a first transmit signal to a first transmitter and a second transmit signal to a second transmitter; and
a receiver to receive a superimposed receive signal comprising a plurality of receive signal components to originate from the plurality of transmit signals, respectively,
wherein a first receive signal component of the superimposed receive signal to originate from the first transmitter and a second receive signal component of the superimposed receive signal to originate from the second transmitter are to be in quadrature.

2. The system as in claim 1, wherein the first receive signal component is to be delayed relative to the first transmit signal by a first signal propagation delay, and the second receive signal component is to be delayed relative to the second transmit signal by a second signal propagation delay.

3. The system as in claim 2, wherein the first transmitter and the second transmitter are paired based on the first signal propagation delay and the second signal propagation delay.

4. The system as in claim 1, wherein the plurality of receive signal components are to be delayed relative to a plurality of signal propagation delays, respectively,
wherein the plurality of transmitters are ordered according to respective signal propagation delays; and
wherein respective twos of the plurality of transmitters are paired sequentially in order of signal propagation delay.

5. The system as in claim 2, wherein the first transmitter and the second transmitter are paired based on the first signal propagation delay and the second signal propagation delay being more similar to each other than either compared to another signal propagation delay.

6. The system as in claim 1, wherein the first transmit signal and the second transmit signal are in quadrature.

7. The system as in claim 1, comprising phase shift control logic to phase shift the first transmit signal relative to the second transmit signal.

8. The system as in claim 1, comprising:
a plurality of transmit electrodes and a receive electrode positioned to have mutual capacitances between respective ones of the transmit electrodes and the receive electrode at mutual capacitance nodes, wherein a mutual capacitance at a mutual capacitance node deviates when an interfering object is proximate, wherein the plurality of transmit electrodes are to be driven by the plurality of transmit signals, respectively.

9. The system as in claim 2, comprising propagation delay control logic to measure the first signal propagation delay and the second signal propagation delay.

10. The system as in claim 8, wherein the first receive signal component is to be delayed relative to the first transmit signal by a first signal propagation delay, and the second receive signal component is to be delayed relative to the second transmit signal by a second signal propagation delay, and comprising propagation delay control logic to measure the first signal propagation delay and the second signal propagation delay without mutual capacitances at mutual capacitance nodes being deviated by a proximate interfering object.

11. The system as in claim 8, wherein the first receive signal component is delayed relative to the first transmit signal by a first signal propagation delay, and the second receive signal component is delayed relative to the second transmit signal by a second signal propagation delay, and comprising propagation delay control logic to measure the first signal propagation delay and the second signal propagation delay via mutual capacitances at mutual capacitance nodes being deviated by a proximate interfering object.

12. The system as in claim 9, wherein the assign control logic is to assign the first transmit signal to the first transmitter and the second transmit signal to the second transmitter based on measured signal propagation delays.

13. The system as in claim 8, wherein the first and second transmit electrodes are physically adjacent.

14. The system as in claim 13, wherein the assign control logic is to assign the first and second transmit signals to the first and second transmitters based on the first and second transmit electrodes being physically adjacent.

15. The system as in claim 2, wherein the first and second signal propagation delays are to remain substantially constant over time.

16. A method comprising:
transmitting respective ones of a plurality of transmit signals from respective ones of a plurality of transmitters, one transmit signal per transmitter respectively;
assigning a first transmit signal to a first transmitter and a second transmit signal to a second transmitter; and
receiving a superimposed receive signal comprising a plurality of receive signal components originating as the plurality of transmit signals, respectively,
wherein a first receive signal component of the superimposed receive signal originating from the first transmitter and a second receive signal component of the superimposed receive signal originating from the second transmitter are in quadrature.

17. The method as in claim 16, wherein assigning the first transmit signal to the first transmitter and the second transmit signal to the second transmitter is based on a first signal propagation delay and a second signal propagation delay, wherein the first signal propagation delay is a delay of the first receive signal component relative to the first transmit signal and the second signal propagation delay is a delay of the second receive signal component relative to the second transmit signal.

18. The method as in claim 17, wherein assigning the first transmit signal to the first transmitter and the second transmit signal to the second transmitter is based on the first signal propagation delay and the second signal propagation delay being approximately equal.

19. The method as in claim 16, comprising phase shifting the first transmit signal relative to the second transmit signal.

20. The method as in claim 16, comprising:
driving a plurality of transmit electrodes by the plurality of transmit signals, one transmit electrode per transmit signal respectively; and
transmitting the plurality of transmit signals to a receive electrode positioned to have mutual capacitances between the plurality of transmit electrodes and the receive electrode at mutual capacitance nodes, wherein a mutual capacitance at a mutual capacitance node deviates when an interfering object is proximate.

21. The method as in claim 17, comprising measuring the first signal propagation delay and the second signal propagation delay.

22. The method as in claim 20, comprising measuring the first signal propagation delay and the second signal propagation delay without mutual capacitances at mutual capacitance nodes being deviated by a proximate interfering object.

23. The method as in claim 20, comprising measuring the first signal propagation delay and the second signal propagation delay via mutual capacitances at mutual capacitance nodes being deviated by a proximate interfering object.

24. The method as in claim 22, wherein assigning the first transmit signal to the first transmitter and the second transmit signal to the second transmitter is based on measured signal propagation delays.

25. The method as in claim 20, wherein assigning the first transmit signal to the first transmitter and the second transmit signal to the second transmitter is based on the first and second transmit electrodes being physically adjacent.

26. A capacitive touch system comprising:
a first transmitter to transmit a first transmit signal;
a second transmitter to transmit a second transmit signal;
first and second transmit electrodes and a receive electrode positioned to have mutual capacitances between respective ones of the first and second transmit electrodes and the receive electrode at mutual capacitance nodes, wherein a mutual capacitance at a mutual capacitance node deviates when an interfering object is proximate, wherein the first and second transmit electrodes are physically adjacent, wherein the first and second transmit electrodes are to be driven by the first and second transmit signals, respectively; and
a receiver to receive a superimposed receive signal comprising first and second receive signal components, wherein the first receive signal component of the superimposed receive signal to be received from the first transmitter and the second receive signal component of the superimposed receive signal to be received from the second transmitter are to be in quadrature.

27. A non-transitory computer-readable storage medium comprising software code adapted, when executed on a data processing apparatus, to assign a first transmit signal to a first transmitter and a second transmit signal to a second transmitter, so that a receiver to receive a superimposed receive signal comprising a plurality of receive signal components to originate from the first and second transmit signals, respectively, wherein a first receive signal component of the superimposed receive signal to originate from the first transmitter and a second receive signal component of the superimposed receive signal to originate from the second transmitter are to be in quadrature.
